(19) United States
(12) Patent Application Publication
(10) Pub. No.: US 2019/0118248 A1
(43) Pub. Date: Apr. 25, 2019

(54) ROLL PRESS MACHINE

(71) Applicant: Panasonic Intellectual Property Management Co., Ltd., Osaka (JP)

(72) Inventors: YOSHIE TAKAHASHI, Osaka (JP); KAZUTO FUKUDA, Osaka (JP); TOSHIFUMI NAGINO, Osaka (JP)

(21) Appl. No.: 16/161,054

(22) Filed: Oct. 16, 2018

(30) Foreign Application Priority Data
Oct. 23, 2017 (JP) 2017-204125

(51) Int. Cl. B22D 11/06; B28B 3/12

(52) U.S. Cl. CPC B22D 11/06; B28B 3/126

(57) ABSTRACT

A roll press machine according to the present disclosure includes a hot press mechanism having a pair of rollers arranged with a gap therebetween and heating mechanisms that heat the pair of rollers to heat and roll a forming material, a material feeding mechanism that feeds the forming material and a conveying mechanism that conveys the forming material fed by the material feeding mechanism to the hot press mechanism, in which each of the pair of rollers in the hot press mechanism has a roller structure including an outermost layer and an intermediate layer inside the outermost layer, and a thermal expansion coefficient of the outermost layer is lower than a thermal expansion coefficient of the intermediate layer.

### TECHNICAL FIELD

The technical field relates to a roll press machine that performs hot rolling with respect to a powdery or sheet-shaped forming material.

### BACKGROUND

As pressurization mechanisms that perform pressurization treatment to objects to be pressurized such as film, paper, nonwoven fabric, metal foil and steel sheet, a batch-type pressurization mechanism and a continuous-type pressurization mechanism have been widely known in the past. The batch-type pressurization mechanism adopts a method of performing pressurization treatment to the object to be pressurized by hydraulic/pneumatic mechanisms or the like in a state where the object to be pressurized is sandwiched between a pair of pressing plates. In the case of the batch-type pressurization mechanism, a process of sandwiching the object to be pressurized between the pressing plates, a process of performing pressurization treatment and a process of taking out the pressurized object to be pressurized are necessary, therefore, productivity is low. On the other hand, a roller-type pressurization treatment widely known as the continuous-type pressurization treatment is a method in which a pair of rollers are arranged to face each other vertically or in parallel and the object to be pressurized is inserted into a gap between rollers to perform pressurization treatment. As the process of taking out the object to be pressurized can be continuously performed after the object to be pressurized is inserted into the gap between rollers and pressurization treatment is performed, there is an advantage that high productivity can be obtained.

However, in the continuous-type pressurization treatment with a pair of rollers, the object to be pressurized is expanded in a travelling direction and a width direction of the rollers during the pressurization treatment, therefore, there are problems such that a desired pressure is not sufficiently transmitted and the object to be pressurized is deformed due to large expansion.

In JP-A-2011-181391 (Patent Literature 1), a pressurization device in which a pair of rollers each including an outer peripheral surface layer and an intermediate layer inside the outer peripheral surface layer and a relation between a hardness of the outer peripheral surface layer and a hardness of the intermediate layer is set so that the hardness of the outer peripheral surface layer is higher than the hardness of the intermediate layer to thereby perform pressurization treatment to the object to be pressurized by surfaces to suppress deformation of the object to be pressurized is described.

However, in a case where a further higher density is required or in a case where pressurization treatment of hard materials such as ceramic is performed, it is difficult to sufficiently transmit a desired pressure to the object to be pressurized due to deformation of the intermediate layer.

### SUMMARY

The present disclosure has been made for solving the above related-art problems and an object thereof is to provide a roll press machine capable of suppressing expansion of the object to be pressurized and uniformly transmitting a desired pressure to the object to be pressurized.

A roll press machine according to the present disclosure includes a hot press mechanism having a pair of rollers arranged with a gap therebetween and heating mechanisms that heat the pair of rollers to heat and roll a forming material, a material feeding mechanism that feeds the forming material and a conveying mechanism that conveys the forming material fed by the material feeding mechanism to the hot press mechanism, in which each of the pair of rollers in the hot press mechanism has a roller structure including an outermost layer and an intermediate layer inside the outermost layer, and a thermal expansion coefficient of the outermost layer is lower than a thermal expansion coefficient of the intermediate layer.

According to the structure, each of the pair of rollers in the hot press mechanism has the roller structure including the outermost layer and the intermediate layer inside the outermost layer, and the thermal expansion coefficient of the outermost layer is lower than the thermal expansion coefficient of the intermediate layer, therefore, it is possible to suppress expansion of the object to be pressurized and to uniformly transmit a desired pressure to the object to be pressurized.

### BRIEF DESCRIPTION OF THE DRAWINGS

FIG. 1 is the entire structure view of a roll press machine according to Embodiment 1 of the present disclosure;

FIGS. 2A to 2H are views of pressurization treatment processes and enlarged views of relevant parts in respective processes according to Embodiment 1;

FIG. 3 is a process view seen just before a forming material of an object to be pressurized is conveyed to a hot press mechanism according to Embodiment 1;

FIG. 4 is a process view seen just after the forming material is pressurized by the hot press mechanism according to Embodiment 1;

FIG. 5 is a process view seen after the forming material is pressurized by the hot press mechanism according to Embodiment 1;

FIGS. 6A and 6B are views of the hot press mechanism seen from a downstream side of the forming material in a direction of pressurization treatment; and

FIG. 7 is an entire structure view of a roll press machine according to Embodiment 2.

### DESCRIPTION OF EMBODIMENTS

Hereinafter, a roll press machine according to the disclosure will be explained based on embodiments.

### Embodiment 1

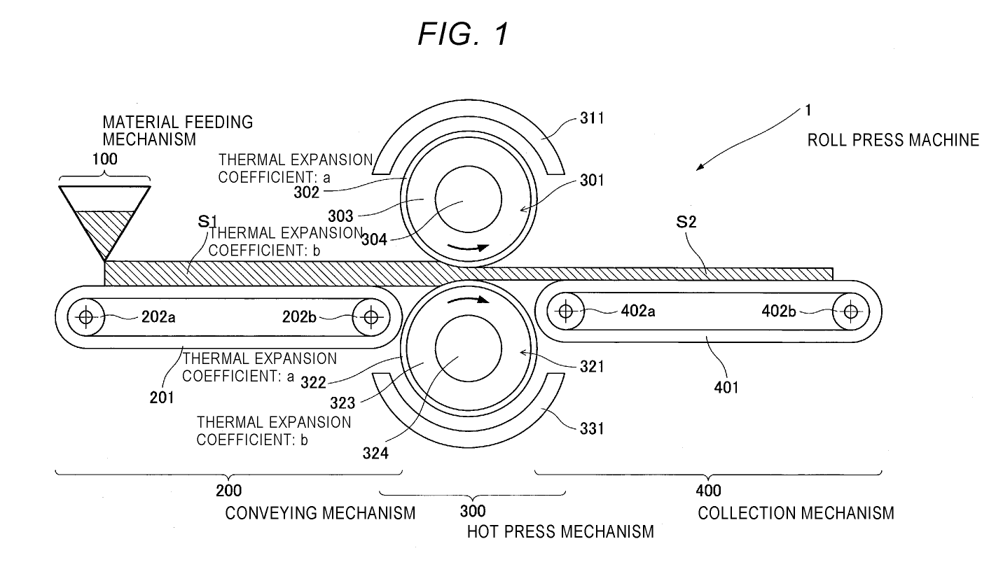

FIG. 1 shows a roll press machine 1.

In the roll press machine 1, a material feeding mechanism 100, a conveying mechanism 200, a hot press mechanism 300 and a collection mechanism 400 are arranged from an upstream side in a direction of pressurization treatment toward a downstream side in a feeding direction.

The material feeding mechanism 100 supplies a powdery or sheet-shaped forming material S1 to the conveying mechanism 200. The conveying mechanism 200 includes a conveying belt conveyor 201 and pulleys for the conveying belt conveyor 202a and 202b, conveying the forming material S1 to the hot press mechanism 300.

The hot press mechanism 300 includes a pair of rollers 301 and 321 arranged apart from each other in a vertical direction, an external heating mechanism 311 arranged close to the roller 301 and heating the roller 301 and an external heating mechanism 331 arranged close to the roller 321 and heating the roller 321. Arrows in the rollers 301 and 321 indicate rotating directions.

The external heating mechanisms 311 and 331 can use methods capable of heating the rollers to a required temperature which are, for example, an induction heating method, a lamp heating method, an infrared heating method, a resistance heating method and so on, not particularly limited. The heating temperature is preferably 100° C. or more for increasing the density and for shaping hard materials such as ceramic. It is preferable to perform heating to 300° C. or more for further increasing productivity.

As a temperature in a bearing part is increased and the lifetime of the bearing or the like is drastically reduced when the temperature of the rollers 301 and 321 exceeds 650° C., the heating temperature is preferably 300° C. or more to 650° C. or less. That is, the maximum heating temperature on respective surfaces of the pair of rollers by the heating mechanisms will be preferably 300° C. or more to 650° C. or less.

The collection mechanism 400 that collects a forming material S2 pressurized by the hot press mechanism 300 includes a collection belt conveyor 401 and pulleys 402a and 402b for the collection belt conveyor 401.

The roller 301 is formed with an outermost layer 302 provided on the outer side of a core part 304 through an intermediate layer 303. The outermost layer 302 is made of a material having a smaller thermal expansion coefficient than a thermal expansion coefficient of a material of the intermediate layer 303.

The roller 321 is formed with an outermost layer 322 provided on the outer side of a core part 324 through an intermediate layer 323. The outermost layer 322 is made of a material having a smaller thermal expansion coefficient than a thermal expansion coefficient of a material of the intermediate layer 323. That is, the roll press machine 1 includes the hot press mechanism 300 having a pair of rollers arranged with a gap therebetween and heating mechanisms that heat the pair of rollers to heat and roll the forming material, the material feeding mechanism 100 that feeds the forming material and the conveying mechanism 200 that conveys the forming material fed by the material feeding mechanism 100 to the hot press mechanism 300. Each of the pair of rollers of the hot press mechanism 300 has a roller structure including the outermost layer 302/322 and the intermediate layer 303/323 inside the outermost layer 302/322, and the thermal expansion coefficient of the outermost layer 302/322 is smaller than the thermal expansion coefficient of the intermediate layer 303/323. Here, materials of the pair of rollers may be the same.

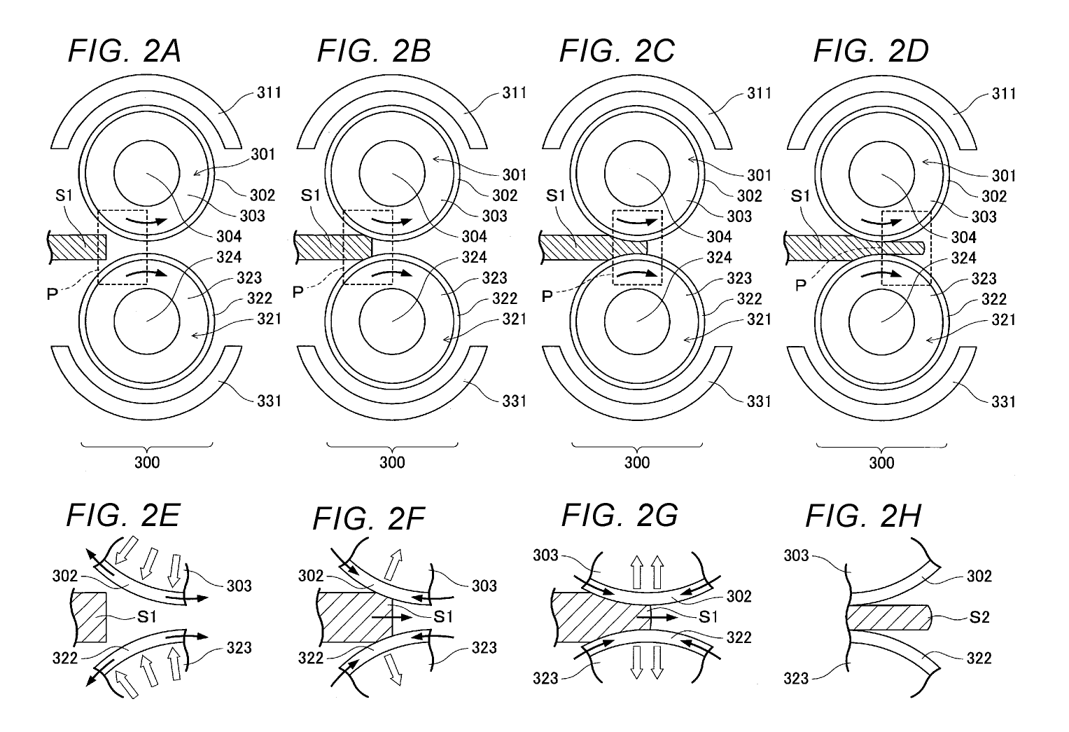

Steps of pressurization treatment by the hot press mechanism 300 are shown in FIGS. 2A to 2H. FIGS. 2A to 2D show steps of heat treatment. Moreover, FIG. 2E shows an enlarged view of a portion P surrounded by a square in FIG. 2A. FIGS. 2F to 2H show enlarged views of portions P surrounded by squares in FIGS. 2B to 2D. In FIGS. 2E to 2H, arrows indicate directions of force.

FIG. 2A shows a state where the forming material S1 as an object to be pressurized is not fed between the rollers 301 and 321 yet.

As the rollers 301 and 321 are heated to a predetermined temperature by the external heating mechanisms 311 and 331 while being rotated, dimensional change occurs in the intermediate layer 303 and the outermost layer 302 of the roller 301 respectively due to thermal expansion. Dimensional change occurs in the intermediate layer 323 and the outermost layer 322 of the roller 321 respectively due to thermal expansion.

Next, as shown in FIG. 2B, when the forming material S1 having a lower temperature than temperatures of the rollers 301 and 321 is fed between the rollers 301 and 321, surface temperatures of the rollers 301 and 321 are accordingly reduced, and the dimensional change due to thermal expansion in the intermediate layer 303 and the outermost layer 302 of the roller 301 is reduced. The dimensional change due to thermal expansion in the intermediate layer 323 and the outermost layer 322 of the roller 321 is reduced. Then, the outermost layers 302 and 322 are compressed with the reduction of the roller surface temperatures as shown in FIG. 2F.

As shown in FIG. 2C and FIG. 2G, the roller surface temperatures are further reduced by being pressurized, and the dimensional change due to thermal expansion in the intermediate layers 303, 323 and the outermost layers 302, 322 is reduced, then, the outermost layers 302 and 322 are further compressed.

The forming material S1 is pressurized while being expanded in a feeding direction by the rollers 301 and 321. As the outermost layers 302 and 322 are compressed in an opposite direction to the direction in which the forming material S1 is expanded, friction occurs on contact surfaces between the outermost layers 302, 322 and the forming material S1. Therefore, expansion in the feeding direction can be suppressed and a desired pressure is uniformly transmitted to the forming material S1, then, the forming material S2 obtained by performing pressurization treatment to the forming material S1 is discharged from the hot press mechanism 300 as shown in FIG. 2D and FIG. 2H.

When manufacturing the rollers 301 and 321, the outermost layers 302 and 322 are coated on surfaces of the intermediate layers 303 and 323 while being heated at a temperature from approximately 200° C. to 600° C. or less. That is, the outermost layer 302 is formed by being coated on the intermediate layer 303. The outermost layer 322 is formed by being coated on the intermediate layer 323. After that, the dimensional change occurs in the rollers 301 and 321 which are at the room temperature (approximately 20° C.) due to thermal expansion.

As the thermal expansion coefficient of the outermost layer 302 is smaller than the thermal expansion coefficient of the intermediate layer 303 and the thermal expansion coefficient of the outermost layer 322 is smaller than the thermal expansion coefficient of the intermediate layer 323, the outermost layers 302 and 322 are in the compressed state due to the dimensional change of the intermediate layers 303 and 323, therefore, internal stresses are increased.

The outermost layers 302 and 322 are in a high temperature state close to the temperature at which coating is performed in the state of FIG. 2A where the object to be pressurized is not fed between the rollers yet, therefore, the internal stresses generated from the difference in thermal expansion coefficients between the outermost layers 302, 322 and the intermediate layers 303, 323 are small, and the outermost layers 302 and 322 are in a stable state.

As the roller surface temperatures are reduced along with transition from the state shown in FIG. 2B to FIG. 2C, the internal stresses of the outermost layers 302 and 322 are increased. That is, the internal stresses in respective outermost layers of the pair of rollers are higher at a position where pressurization treatment is completed than at a position where the forming material is not fed yet. The hardness of the outermost layers 302 and 322 is accordingly increased, therefore, the forming material S2 is easily released from the rollers 301 and 321 in the state of FIG. 2D.

A difference (b-a) between a thermal expansion coefficient “a” of the outermost layers 302, 322 and a thermal expansion coefficient “b” of the intermediate layers 303, 323 is preferably 1×10⁻⁶/K or more to 10×10⁻⁶/K or less. When the coefficient is less than 1×10⁻⁶/K, the difference in thermal expansion coefficient is small and the internal stresses on the outermost layers are not generated. When the coefficient is greater than 10×10⁻⁶/K, the difference in thermal expansion coefficient is large, which may be a factor of a crack or peeling.

Materials for the outermost layers 302, 322 and the intermediate layers 303, 323 are not particularly limited as far as materials satisfy the condition that the difference in thermal expansion coefficient (b-a) is 1×10⁻⁶/K or more to 10×10⁻⁶/K or less and can be used at 300° C. or more to 650° C. or less. For example, as materials for the outermost layers 302 and 322, there are nitrides such as aluminum nitride, titanium nitride, chromium nitride, silicon nitride, aluminum-chromium nitride and titanium-aluminum nitride, oxides such as zirconia and alumina, carbides such as chromium carbide and tungsten carbide, compounds of a nitride, an oxide and a carbide such as titanium carbonitride and so on. As materials for the intermediate layers 303 and 323, there are die steels such as SKD11 and SKD61, high-speed steels such as SKH50 and SKH40, high carbon iron alloys, Ni alloys, Co alloys and so on.

Materials for the core parts 304 and 324 are not particularly limited as far as a desired strength can be obtained at a predetermined temperature by the materials. For example, the same materials as materials for the intermediate layers 303 and 323 or different materials from those may be adopted.

In addition to the compression of the roller outermost layers 302 and 322, a hardness “c” of the roller 301 positioned above is preferably lower than a hardness “d” of the roller 321 positioned below in the pair of rollers 301 and 321.

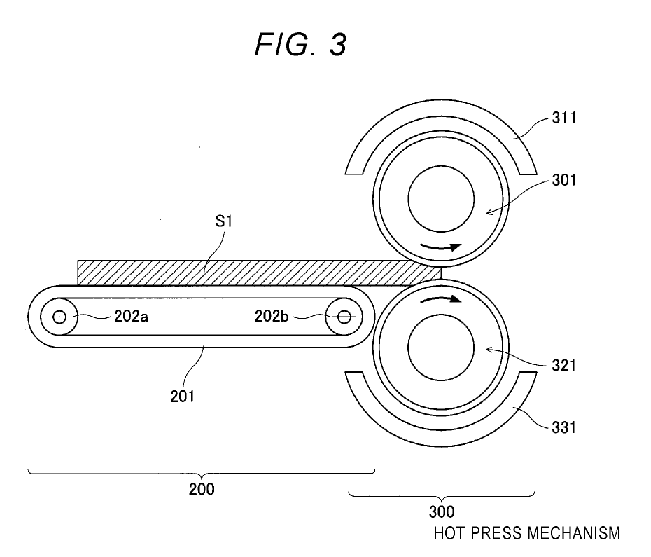

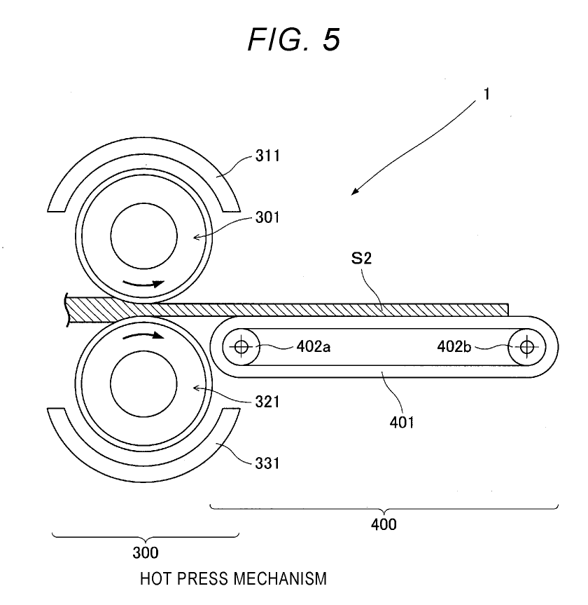

Steps from feeding of the forming material 51 to collection of the forming material S2 in the case where there is a difference in hardness between the upper and lower rollers 301 and 321 are shown in FIG. 3 to FIG. 5.

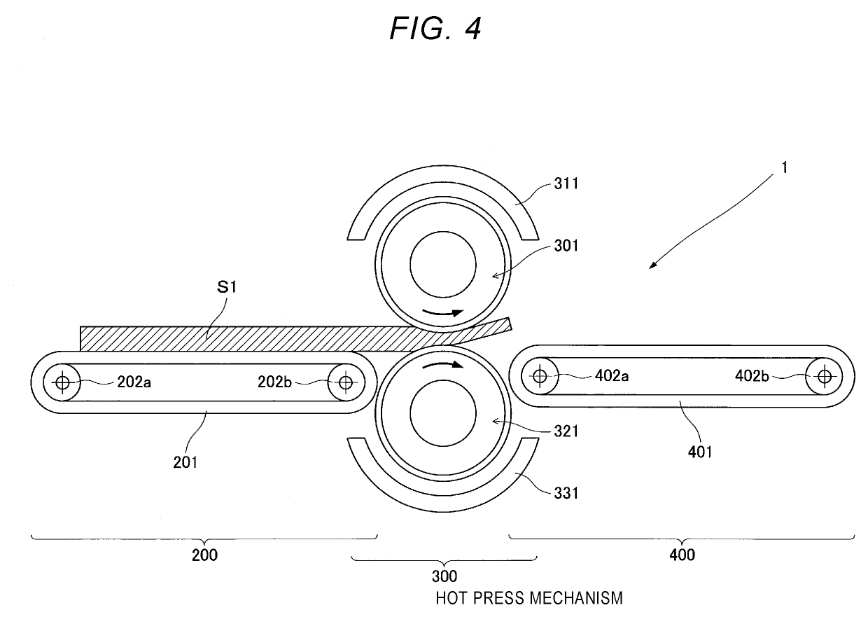

As shown in FIG. 3, the forming material 51 is conveyed to the hot press mechanism 300 by the conveying belt conveyor 201 of the conveying mechanism 200. As the hardness of the roller 301 positioned above is made to be lower than the hardness of the roller 321 positioned below, an elastic deformation amount of the roller 301 positioned above is larger than an elastic deformation amount of the roller 321 positioned below when the forming material S2 is pressurized, therefore, the forming material S2 is lifted in a direction of the roller 301 just after the hot press as shown in FIG. 4.

The weight of the lifted forming material S2 acts in the direction of the roller 321 positioned below, therefore, the forming material S2 is conveyed in parallel to the traveling direction and is collected by the collection belt conveyor 401 of the collection mechanism 400 smoothly, as a result, a high yield can be obtained.

A difference in hardness (d-c) between the hardness “c” of the roller 301 and the hardness “d” of the roller 321 is preferably 1HV or more and 200Hv or less in Vickers hardness. When the hardness is less than 1Hv, it is difficult to lift up the forming material S2. When the hardness is greater than 200Hv, it is difficult to uniformly transmit the pressure in upper and lower directions of the forming material S1, which leads to non-uniform workmanship. The hardness is measured by well-known hardness measurement methods such as Vickers hardness, Shore hardness, Rockwell hardness and Brinell hardness.

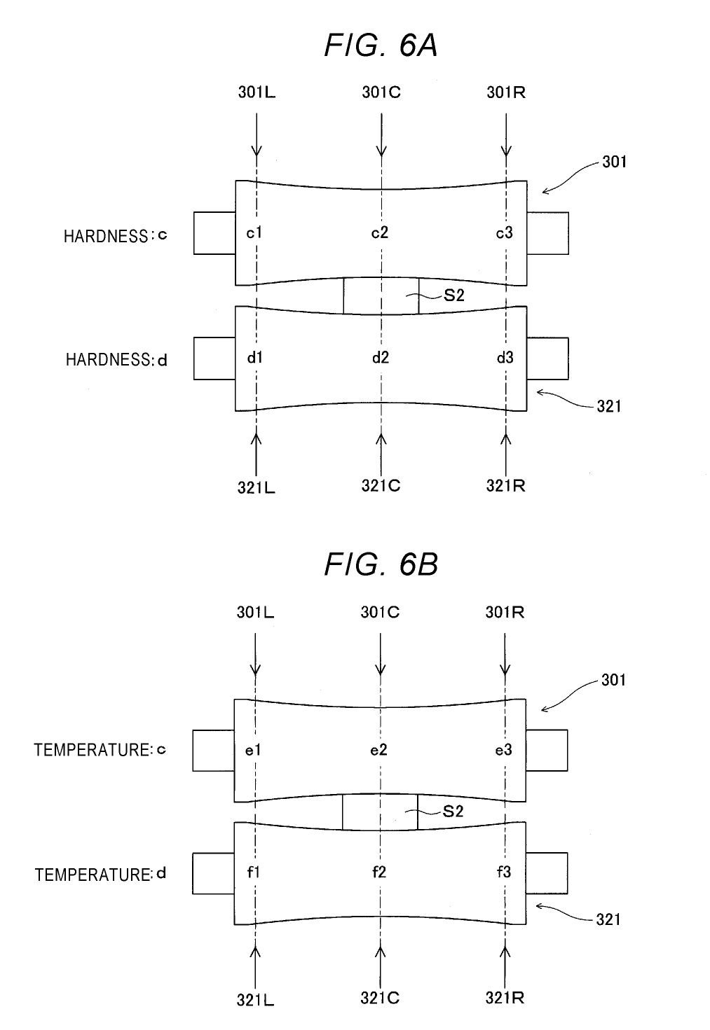

FIGS. 6A and 6B show states where the forming material S2 is pressurized by the hot press mechanism 300 according to the embodiment. FIG. 6A is an explanatory view relating to hardnesses of the rollers. FIG. 6B is an explanatory view relating to temperatures of the rollers. Here, the fact that the hardness “c” of the roller 301 positioned above is lower than the hardness “d” of the roller 321 positioned below means that, for example, a hardness “c1” at an arbitrary position 301L from a left end part of the roller 301 is lower than a hardness “d1” at an arbitrary position 321L from a left end part of the roller 321, a hardness “c3” at an arbitrary position 301R from a right end part of the roller 301 is lower than a hardness “d3” at an arbitrary position 321R from a right end part of the roller 321, and a hardness “c2” at a central part 301C between the left end part and the right end part of the roller 301 is lower than a hardness “d2” at a central part 321C between the left end part and the right end part of the roller 321.

The hardnesses of the roller 301 positioned above and the roller 321 positioned below in the pair of rollers arranged with a gap therebetween in the vertical direction can be easily changed by controlling the temperature. That is because there is generally a strong correlation between the material temperature and the hardness. The hardnesses “c” and “d” of the roller 301 and the roller 321 in this disclosure are respectively controlled by the material temperatures of the roller 301 and the roller 321. Therefore, it is characterized that a temperature “e” of the roller 301 is higher than a temperature “f” of the roller 321. It is preferable that a temperature difference (e-f) satisfies a condition of 5° C. or more and 100° C. or less. That is for obtaining the hardness for uniformly pressurize the forming material as well as for collecting the forming material smoothly.

Here, the fact that the temperature is high means that, for example, a temperature at an arbitrary position 301L from a left end part of the roller 301 is higher than a temperature at an arbitrary position 321L from a left end part of the roller 321, a temperature at an arbitrary position 301R from a right end part of the roller 301 is higher than a temperature at an arbitrary position 321R from a right end part of the roller 321, and a temperature at a central part 301C between the left end part and the right end part of the roller 301 is higher than a temperature at a central part 321C between the left end part and the right end part of the roller 321.

It is characterized that the hardness “c2” at the central part 301C is lower than the hardness “c1” at the arbitrary position 301L from the left end part and the hardness “c3” at the arbitrary position 301R from the right end part in the roller 301 of the hot press mechanism 300 according to the embodiment.

Furthermore, it is preferable that hardness differences (c2−c1) and (c2−c3) satisfy a condition of 1Hv or more or 200Hv or less in

Vickers hardness. An elastic deformation amount at the central part 301C of the roller 301 is larger than an elastic deformation amount at the arbitrary position 301L from the left end part or the arbitrary position 301R from the right end part, therefore, the forming material is not easily expanded from the central part to end part directions of the roller 301 when the forming material is pressurized, as a result, pressure is sufficiently transmitted to end parts of the forming material.

The differences in hardness c2<c1, c2<c3 in the roller 301 may be easily changed by controlling the temperature. That is because there is generally a strong correlation between the material temperature and the hardness. The differences between the hardness at the central part 301C of the roller 301 and the hardnesses at the arbitrary position 301L from the left end part and at the arbitrary position 301R from the right end part are respectively controlled by a material temperature at the central position 301C of the roller 301, a material temperature at the arbitrary position 301L of the left end part and a material temperature at the arbitrary position 301R of the right end part.

Accordingly, it is characterized that a temperature “e2” at the central part 301C of the roller 301 is higher than a temperature “e1” at the arbitrary position 301L from the left end part and a temperature “e3” at the arbitrary position 301R from the right end part, and a temperature difference (e2−e1) or a temperature difference (e2−e3) is preferably 5° C. or more to 100° C. or less. According to this, the pressure is sufficiently transmitted to end parts of the forming material.

In the roller 321, it is characterized that the hardness “d2” at the central part 321C is lower than the hardnesses “d1” and “d3” at the arbitrary position 321L from the left end part and at the arbitrary position 321R from the right end part, and it is preferable that a hardness difference (d2−d1) or a hardness difference (d2−d3) satisfies a condition of 1Hv or more to 200Hv or less in Vickers hardness. As an elastic deformation amount at the central part 321C of the roller 321 is larger than an elastic deformation amount at the arbitrary position 321L from the left end part or at the arbitrary position 321R from the right end part, the forming material is not easily expanded from the central part to end part directions of the roller 321 when the forming material is pressurized, as a result, pressure is sufficiently transmitted to end parts of the forming material.

The differences in hardness d2<d1, d2<d3 in the roller 321 may be easily changed by controlling the temperature. That is because there is generally a strong correlation between the material temperature and the hardness. The differences between the hardness at the central part 321C of the roller 321 and the hardnesses at the arbitrary position 321L from the left end part and at the arbitrary position 321R from the right end part are respectively controlled by a material temperature at the central position 321C of the roller 321, a material temperature at the arbitrary position 321L of the left end part and a material temperature at the arbitrary position 321R of the right end part.

Accordingly, it is characterized that a temperature “f2” at the central part 321C of the roller 321 is higher than a temperature “f1” at the arbitrary position 321L from the left end part and a temperature “f3” at the arbitrary position 321R from the right end part, and a temperature difference (f2−f1) or a temperature difference (f2−f3) is preferably 5° C. or more to 100° C. or less. According to this, the pressure is sufficiently transmitted to end parts of the forming material.

### Embodiment 2

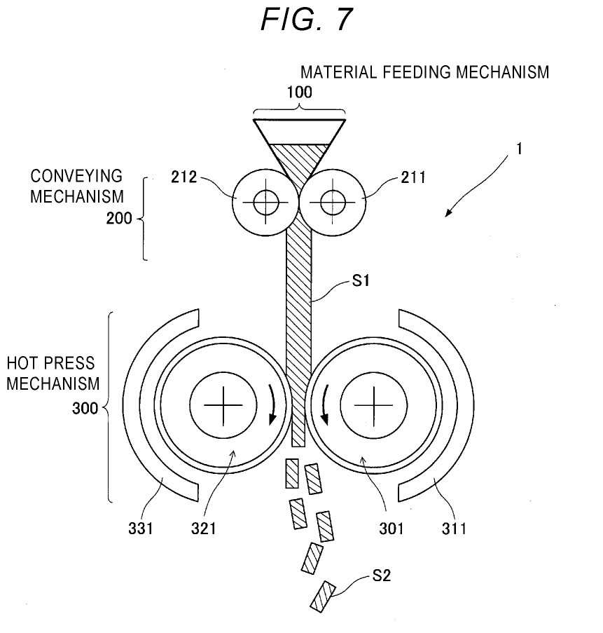

FIG. 7 shows a roll press machine according to Embodiment 2. In Embodiment 2, the conveying mechanism 200 is arranged at a lower position of the material feeding mechanism 100. The hot press mechanism 300 is arranged at a lower position of the conveying mechanism 200.

The conveying mechanism 200 includes rollers 211 and 212 arranged horizontally with a gap therebetween. The forming material S1 fed between the rollers 211 and 212 from the material feeding mechanism 100 is discharged from above to below while being compressed by the rollers 211 and 212.

The hot press mechanism 300 includes rollers 301 and 321 arranged horizontally with a gap therebetween, an external heating mechanism 311 arranged close to the roller 301 and an external heating mechanism 331 arranged close to the roller 321. The internal structure of the rollers 301 and 321 and the hardnesses in the width direction of the rollers (an axial direction of the rollers 301 and 321) are the same as those of Embodiment 1.

The forming material S1 conveyed from the material feeding mechanism 100 to the hot press mechanism 300 through the conveying mechanism 200 is pressurized by the hot press mechanism 300, and the forming material S2 is discharged further downward from the hot press mechanism 300 just after the hot press.

A direction of pressurization treatment is from the upper position toward the lower position in Embodiment 2, which is different from Embodiment 1 in which the direction of pressurization treatment is the horizontal direction. Other structures are the same as those of Embodiment 1, that is, expansion of the object to be pressurized can be suppressed and the pressure can be uniformly transmitted to the forming material S1 also in Embodiment 2, which is effective also for forming uniform and high density products regardless of the product size.

The example of external heating has been explained as heating devices of the hot press mechanism 300 in the explanation of respective embodiments. The same advantages can be obtained also by an internal heating method as surface conditions of the rollers are similar at the time of performing pressurization treatment of the object to be pressurized.

The roll press machine according to the present disclosure is effective for pressurization treatment of forming materials used for industrial applications such as semiconductor components, in-vehicle parts, biological materials and battery materials.

What is claimed is:

1. A roll press machine comprising:
a hot press mechanism having a pair of rollers arranged with a gap therebetween and heating mechanisms that heat the pair of rollers to heat and roll a forming material;
a material feeding mechanism that feeds the forming material; and
a conveying mechanism that conveys the forming material fed by the material feeding mechanism to the hot press mechanism,
wherein each of the pair of rollers in the hot press mechanism has a roller structure including an outermost layer and an intermediate layer inside the outermost layer, and
a thermal expansion coefficient of the outermost layer is lower than a thermal expansion coefficient of the intermediate layer.

2. The roll press machine according to claim 1,
wherein the maximum heating temperature on surfaces of the respective pair of rollers by the heating mechanisms is 300° C. or more to 650° C. or less.

3. The roll press machine according to claim 1,
wherein internal stresses in the respective outermost layers of the pair of rollers are higher at a position where pressurization treatment is completed than at a position where the forming material is not fed yet.

4. The roll press machine according to claim 1,
wherein a hardness at a central part of an upper roller in the pair of rollers is lower than a hardness at a central part of a lower roller.

5. The roll press machine according to claim 1,
wherein a temperature at the central part of the upper roller in the pair of rollers is higher than a temperature at the central part of the lower roller.

6. The roll press machine according to claim 1,
wherein the hardnesses at the respective central parts of the pair of rollers are lower than hardnesses at end parts of the pair of rollers.

7. The roll press machine according to claim 1,
wherein the temperatures at the respective central parts of the pair of rollers are higher than temperatures at end parts of the pair of rollers.

8. The roll press machine according to claim 1,
wherein materials of the pair of rollers are the same.

9. The roll press machine according to claim 1,
wherein the outermost layers are formed by being coated on the respective pair of rollers.
